(19) United States
(12) Patent Application Publication
(10) Pub. No.: US 2015/0281148 A1
(43) Pub. Date: Oct. 1, 2015

(54) IMMERSIVE DOCUMENT VIEW

(71) Applicant: Microsoft Corporation, Redmond, WA (US)

(72) Inventors: Joseph Masterson, Maple Valley, WA (US); Jeremy de Souza, Bellevue, WA (US); David Paul Limont, Seattle, WA (US); Jin Ma, Redmond, WA (US); Elena Catrinescu, Woodinville, WA (US); Hayley Lynn Steplyk, Redmond, WA (US); David Lloyd Meyers, JR., Seattle, WA (US); Jason Cook, Renton, WA (US); Kenneth Fern, Bellevue, WA (US); Nathan Waddoups, Redmond, WA (US)

(73) Assignee: MICROSOFT CORPORATION, Redmond, WA (US)

(21) Appl. No.: 14/497,236

(22) Filed: Sep. 25, 2014

Related U.S. Application Data
(60) Provisional application No. 61/973,030, filed on Mar. 31, 2014.

(51) Int. Cl. H04L 12/58; G06F 3/0484; G06F 3/0482

(52) U.S. Cl. CPC H04L 51/08; H04L 51/046; G06F 3/0482; G06F 3/04842

(57) ABSTRACT

Immersive document view and use in an electronic communications user interface are provided. If an electronic communications conversation is presented in an electronic communications pane or canvas, a user may navigate through the electronic communications items while a selected content item is maintained in a displayed state in an immersive view pane. The electronic communications conversation thread may be oriented such that oldest communication items are presented at the top, followed by next newer conversation items, and so on. A pop-out function may be provided wherein an editing experience for a selected content item may be popped out into a secondary user interface window in a partially or completely overlaying fashion over a user interface display window containing the components of the electronic communications user interface.

### CROSS-REFERENCE TO RELATED APPLICATIONS

This application claims the benefit of U.S. Provisional Patent Application No. 61/973,030, filed Mar. 31, 2014.

### BACKGROUND

Computer and computer software users have become accustomed to generating, editing, receiving and sending many types of content items, for example, documents of different types, photographs, images, electronic mail items, calendaring items, notes items, and the like. In a typical electronic mail setting, a user often attaches a document or other content item (hereafter referred to as “attachment” or “content item”) to an electronic mail item he/she then sends to a receiving user for review or editing. The receiving user then typically downloads the received attachment to his/her local computing device or to an enterprise (local or remote) storage repository, for example, a company or school file server or a remote server at which the receiving user has a storage location or at a collaborative file storage location at which the sending user and the receiving user store content items for receiving and editing as part of a collaborative work group of any of a number of types.

If the receiving user reviews or edits the attachment, he/she typically saves the edited attachment or content item to the storage location (described above). When the receiving user then desires to reply back to the sending user with the edited attachment or desires to send the edited attachment to other users or desires to add the edited attachment to a calendar entry, task entry, notes entry, meeting request, or the like, the receiving (and editing) user must locate the edited content item at the storage location and must attach the edited content item to the appropriate communication medium (e.g. email, text message, instant message, video conference, calendar entry, notes entry, task entry, meeting request, etc.). For example, the receiving user may then attach the edited content item to a reply email that may be sent back to the sending user for review. Such a receive, store, edit, store, retrieval, attachment, disposition process is time consuming, memory consuming, process consuming and typically frustrating to users. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing immersive document view and use in an electronic communications user interface. When a user receives an electronic communication, the communication may be received in a communications view pane or canvas that is part of an electronic communications user interface. If the received communication includes an attachment, a user may select the attachment in the received communication and the corresponding content item may be automatically displayed in an immersive view pane or canvas within the communications user interface. The user may review and/or edit the displayed attachment and continue with an electronic communications conversation with one or more other users via the electronic communications pane or canvas.

According to an embodiment, if an electronic communications conversation is presented in the electronic communications pane or canvas, a user may navigate through the electronic communications items while a selected content item is maintained in a displayed state. For example, a user may scroll through a number of different electronic communications sent or received as part of an electronic communications conversation thread. As the user is navigating through the communications conversation thread, he/she may select other attachments for displaying associated content items. According to one embodiment, the electronic communications conversation thread may be oriented such that oldest communication items are presented at the top, followed by next newer conversation items, followed by next newer conversation items, and so on.

According to another embodiment, a pop-out function may be provided wherein an editing experience for a selected content item may be popped out into a secondary user interface window in a partially or completely overlaying fashion over a user interface display window containing the components of the electronic communications user interface. Edits or changes made to content items in either of the primary or secondary user interface windows are automatically reflected in the other of the primary or secondary user interface windows.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### DESCRIPTION OF THE DRAWINGS

FIG. 1 is simplified block diagram illustrating a system for providing immersive document view and use.

FIG. 2A illustrates a computer-generated user interface of an electronic mail application with which embodiments the present invention may be practiced.

FIG. 2B illustrates a computer-generated user interface of an electronic mail application with an immersive view pane in which a received content item may be displayed for viewing.

FIG. 2C illustrates a computer-generated user interface of an electronic mail application with an immersive view pane in which a received content item may be displayed for viewing.

FIG. 2D illustrates a computer-generated user interface of an electronic mail application with an immersive view pane in which a received content item may be displayed for viewing.

FIG. 2E illustrates a computer-generated user interface of an electronic mail application with an immersive view pane in which a received content item may be displayed for viewing and illustrates an example chat session illustrated in an electronic communications conversation pane.

FIG. 2F illustrates a computer-generated user interface of an electronic mail application with an immersive view pane in which a received content item may be displayed for viewing and illustrates an oldest-to-newest navigation of an electronic communications conversation thread.

FIG. 2G illustrates a computer-generated user interface of an electronic mail application with an immersive view pane in which a received content item may be displayed for viewing and illustrates selection of a pop-out control for popping out a secondary editing user interface.

FIG. 2H illustrates a computer-generated user interface of an electronic mail application with an immersive view pane in which a received content item may be displayed for viewing and illustrates an editing experience in a popped-out secondary user interface.

FIG. 2I illustrates a computer-generated user interface of an electronic mail application with an immersive view pane in which a received content item may be displayed for viewing and illustrates an editing experience in a popped-out secondary user interface.

FIG. 3 is a flowchart illustrating a method for immersive document viewing and use.

FIG. 4 is a block diagram illustrating example physical components of a computing device with which embodiments of the invention may be practiced.

FIGS. 5A and 5B are simplified block diagrams of a mobile computing device with which embodiments of the present invention may be practiced.

FIG. 6 is a simplified block diagram of a distributed computing system in which embodiments of the present invention may be practiced.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

As briefly described above, embodiments of the present invention are directed to providing immersive document view in an electronic communications user interface. When a user receives an electronic communication, for example, an electronic mail item, a text message, an instant message, a chat session message, or the like, the communication may be received in a communications view pane or canvas that is part of an electronic communications user interface having a number of components such as folder panes, communication listing panes, calendar panes, and the like. According to an embodiment, if the received communication includes an attachment corresponding to a content item, for example, an attached document, dataset, image, photograph, video or the like, a user may select the attachment in the received communication, and the corresponding content item may be automatically displayed in an immersive view pane or canvas within the user interface in which the user has received the electronic communication.

The immersive view pane may be displayed in a side-by-side or top/bottom orientation relative to the electronic communications pane or canvas such that the user may simultaneously review and/or edit the selected content item and review the electronic communications pane or canvas. Thus, the user may review and continue with an electronic communications conversation with one or more other users via the electronic communications pane or canvas while simultaneously keeping a display of the selected document in the immersive view pane. Such a configuration allows for enhanced collaboration with other users, particularly, where an electronic communications conversation involves one or more content items that may be displayed in the immersive view pane to allow users to view and/or edit content items contained in the immersive view pane while carrying on an electronic communication conversation about the being-viewed and/or being-edited content item.

If the user edits the content item displayed in the immersive view pane, then functionality associated with the content item type, for example, word processing functionality, spreadsheet application functionality, slide presentation application functionality, notes taking functionality, and the like, may be presented in the immersive view pane with the disclosed document to allow the user to apply such functionality to the displayed content item for editing the content item as desired. After any or all edits are made to such a displayed content item, an edited version of the content item may be stored with the received electronic mail message at an electronic mail server, or the edited content item may be stored at another storage location as desired by the user.

As described above, if an electronic communications conversation is presented in the electronic communications pane or canvas while a selected content item is displayed in the immersive view pane, a user may navigate through the electronic communications items while the selected content item is maintained in its displayed state. For example, a user may scroll through a number of different electronic communications sent or received as part of an electronic communications conversation thread. As the user is navigating through the communications conversation thread, if the user sees an attachment at some other point in the communications conversation thread of interest to the user, the user may select that attachment, and the presently displayed content item will be replaced with a display of the content item associated with the newly-selected attachment.

The electronic communications conversation thread provided in the electronic communications pane or canvas may be oriented such that oldest communication items are presented at the top, followed by next newer conversation items, followed by next newer conversation items, and so on. Thus, when the user is navigating through various conversation items contained in a given electronic communications conversation thread, a downward navigation from top to bottom will result in the user seeing newer conversation items as he/she navigates in a downward fashion through the items contained and presented in the electronic communications pane or canvas.

A pop-out function may be provided wherein an editing experience for a selected content item may be popped out into a secondary user interface window in a partially or completely overlaying fashion over a user interface display window containing the components of the electronic communications application user interface. According to this embodiment, if a user is presently displaying a selected content item in an immersive view pane in a side-by-side orientation relative to an electronic communications pane in which an electronic communications thread is displayed, the user may select a pop-out functionality, and a secondary user interface may be popped out from the present user interface. The secondary user interface will contain the immersive view pane with the presently-displayed content item and the electronic communications pane or canvas will contain the presently being-navigated electronic communications thread. A primary user interface, underlying a display of the secondary user interface, may display components of the original electronic communications user interface in a state that existed prior to the user's original selection of a given electronic mail item to open an electronic communications thread from which the user displayed a given content item. Edits or changes made to content items in either of the primary or secondary user interface windows may be automatically reflected in the other of the primary or secondary user interface windows where applicable.

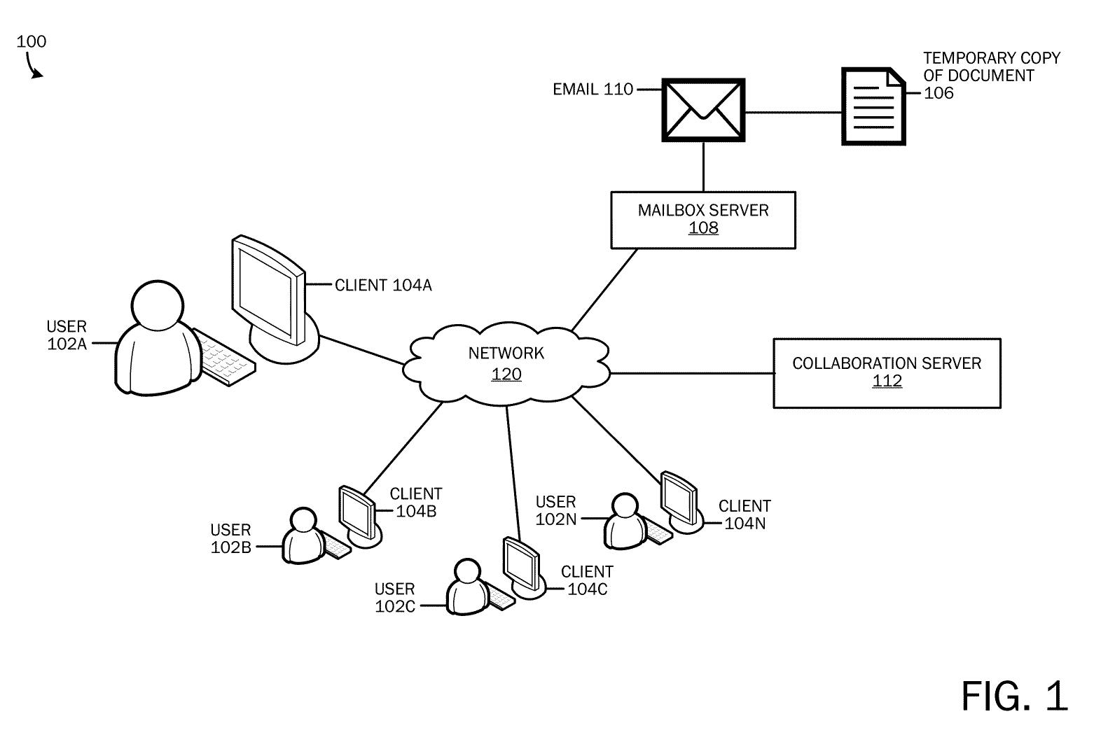

FIG. 1 is simplified block diagram illustrating a system 100 for electronic communication-based storage and use of documents and other content items to support multiple workflows. As illustrated in FIG. 1, a variety of users 102a, 102b, 102c, 102n are illustrated in association with respective client devices 104a, 104b, 104c, 104n. The users and the associated client devices are illustrative of one or more users who may generate, edit, receive, send, or otherwise interact with content items of various types as described herein. The client devices 104a-104n are illustrative of a variety of computing devices, for example, desktop computing devises, laptop computing devices, tablet computing devices, handheld computing devices (mobile phones), and the like. Each of the example computing devices may be interacted with according to a variety of input means, for example, keyboard input, mouse input, electronic pen and ink input, touch input, gesture input, voice input, eye tracking input, and the like. At each of the client devices 104a-104n, a variety of software applications may be provided for allowing the one or more users to interact with a variety of content items. For example, software applications such as electronic mail applications, word processing applications, slide presentation applications, spreadsheet applications, notes taking applications, desktop publishing applications, calendaring applications, image processing and editing applications, video applications and the like may be operated at the client devices by the one or more users 102a-102n. The network 120 is illustrative of an enterprise-based network, for example, an intranet, or a distributed computing network, for example, the Intranet, over which the various users may communicate with each other and with other computing systems, as described herein.

The mailbox server 108 is illustrative of an electronic communication system that may be located local to one of the various users, or that may be located remotely from the various users for allowing electronic mail and other electronic communications between the various users. An example of a server 108 may be an EXCHANGE server from Microsoft Corporation. The electronic communication item 110 (e.g., email item) is illustrative of an electronic communication that may be communicated between one or more users for passing text-based communications, and a variety of attached files, for example, audio files, text files, image files, data files, and the like. The temporary copy of a document 106 is illustrative of a temporary storage of an edited attached content item that is edited in association with an electronic communication item and that is temporarily stored with an electronic communication at the electronic mail server 108 for disposition according to embodiments of the present invention. The collaboration server 112 is illustrative of a local or remote storage repository at which one or more content items may be stored. For example, the collaboration server 112 may be a shared resources server located at an enterprise accessible by the various users, or may be remotely located from the various users at which the various users may store and collaborate on various documents. An example of such a collaboration server 112 may include a SHAREPOINT server or ONEDRIVE server from Microsoft Corporation.

According to embodiments of the present invention, when an attached content item is received and edited by a given user, a temporary copy 106 of the edited content item is stored with the received electronic communication item 110 at the electronic communication server 108. The content item is only stored at the collaboration server 112 if a given user desires to store the received content item apart from the electronic communication server 108 as described with respect to embodiments illustrated and described herein.

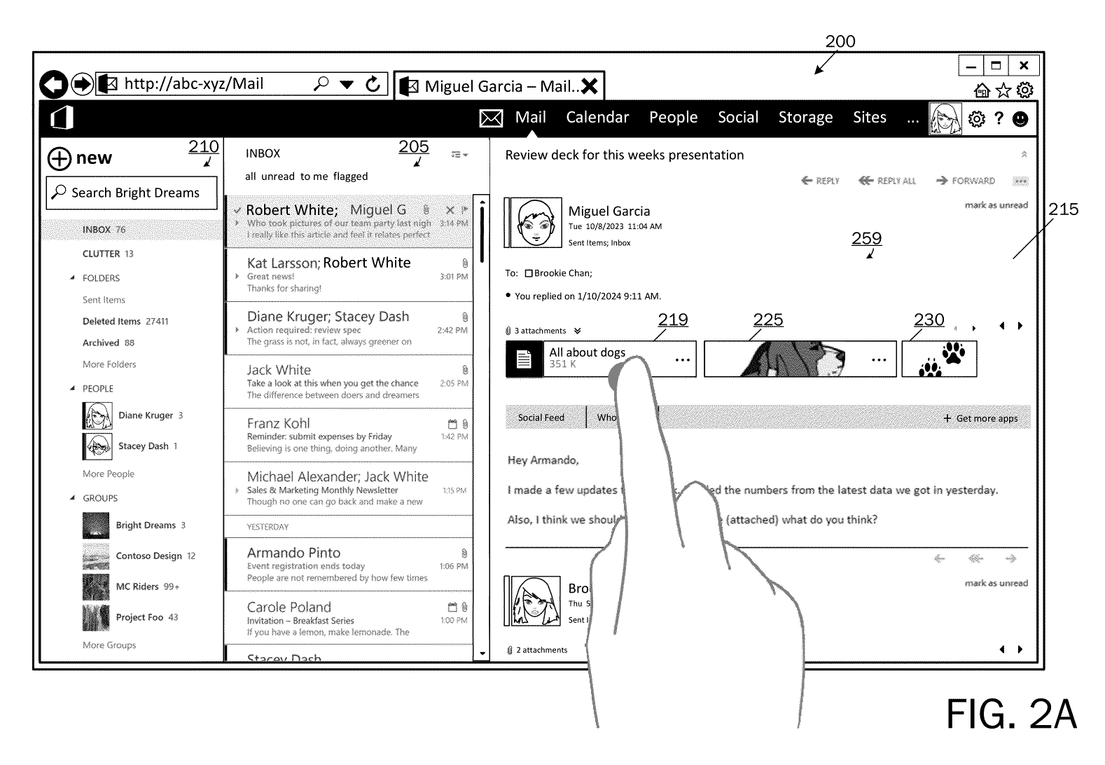

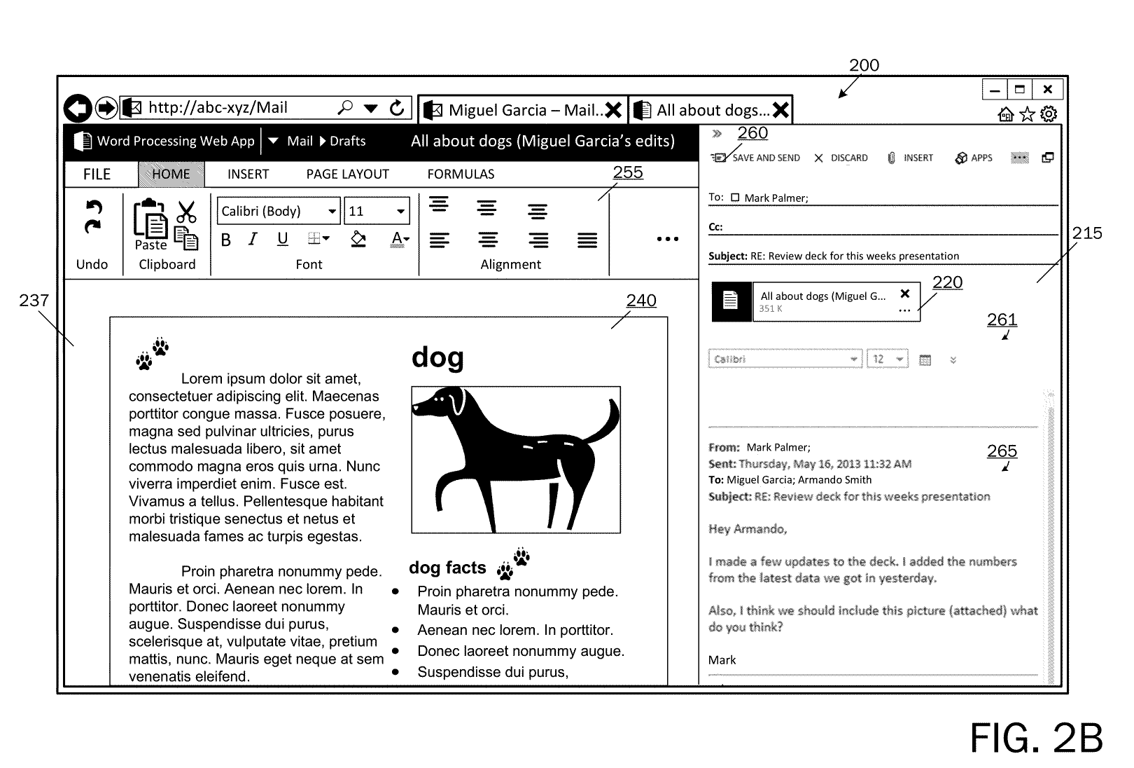

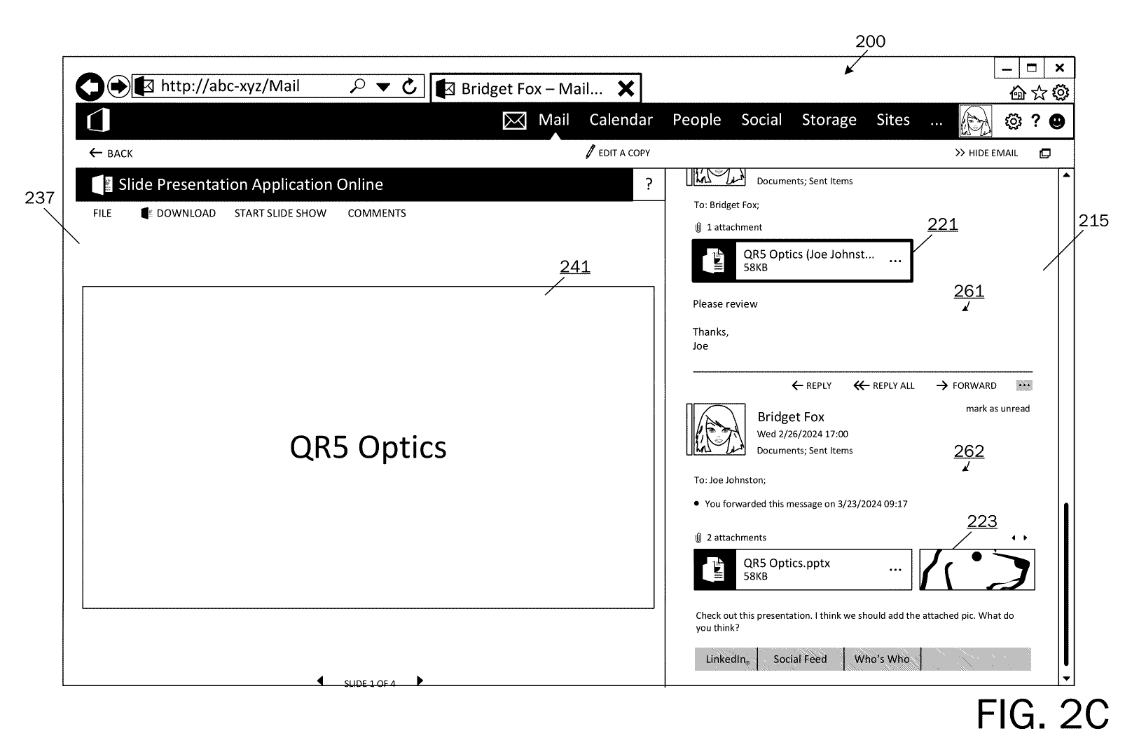

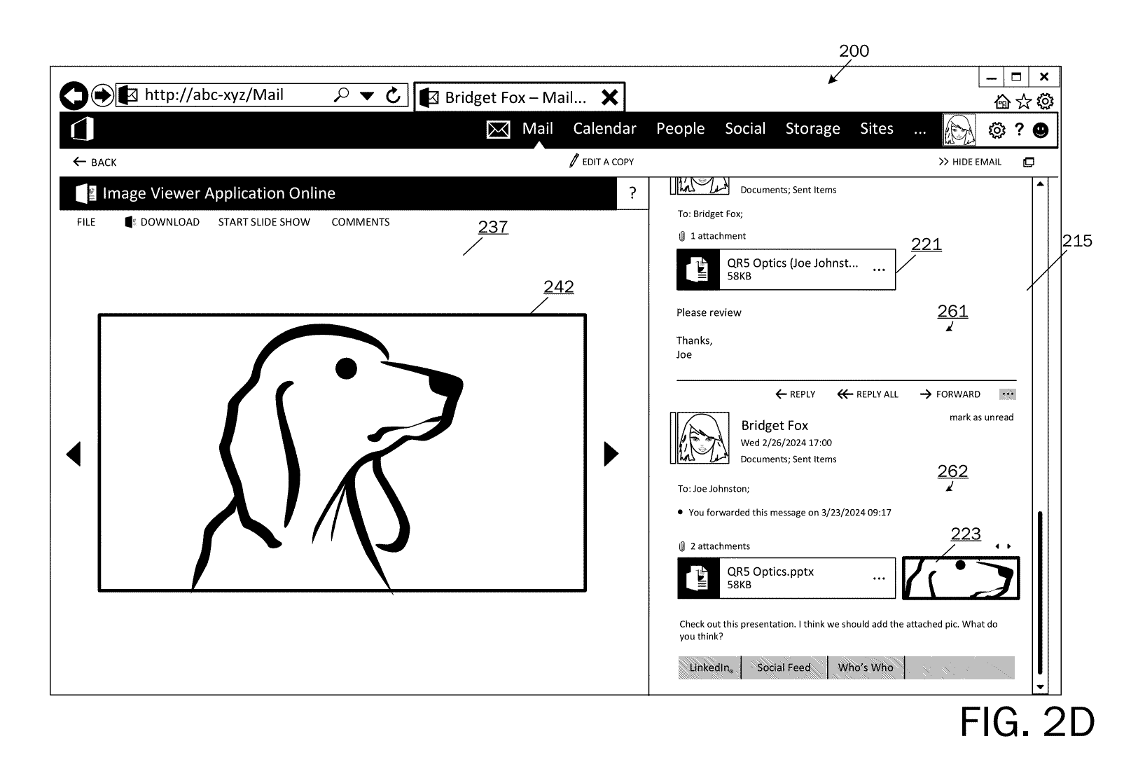

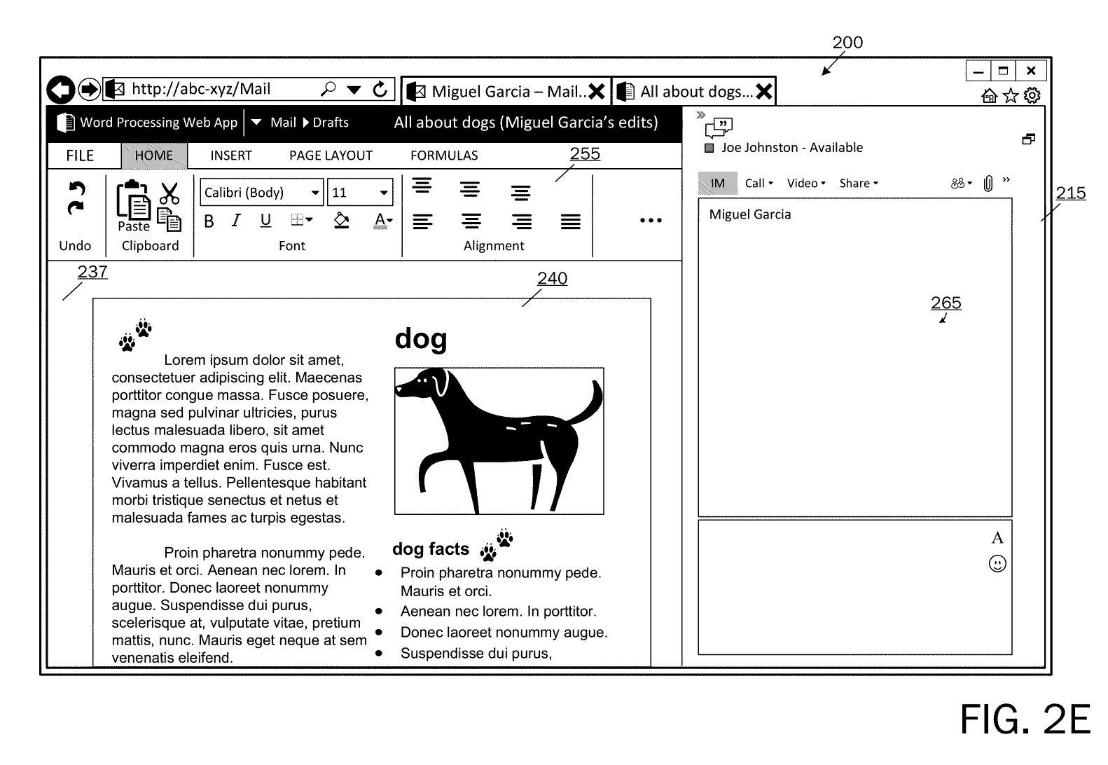

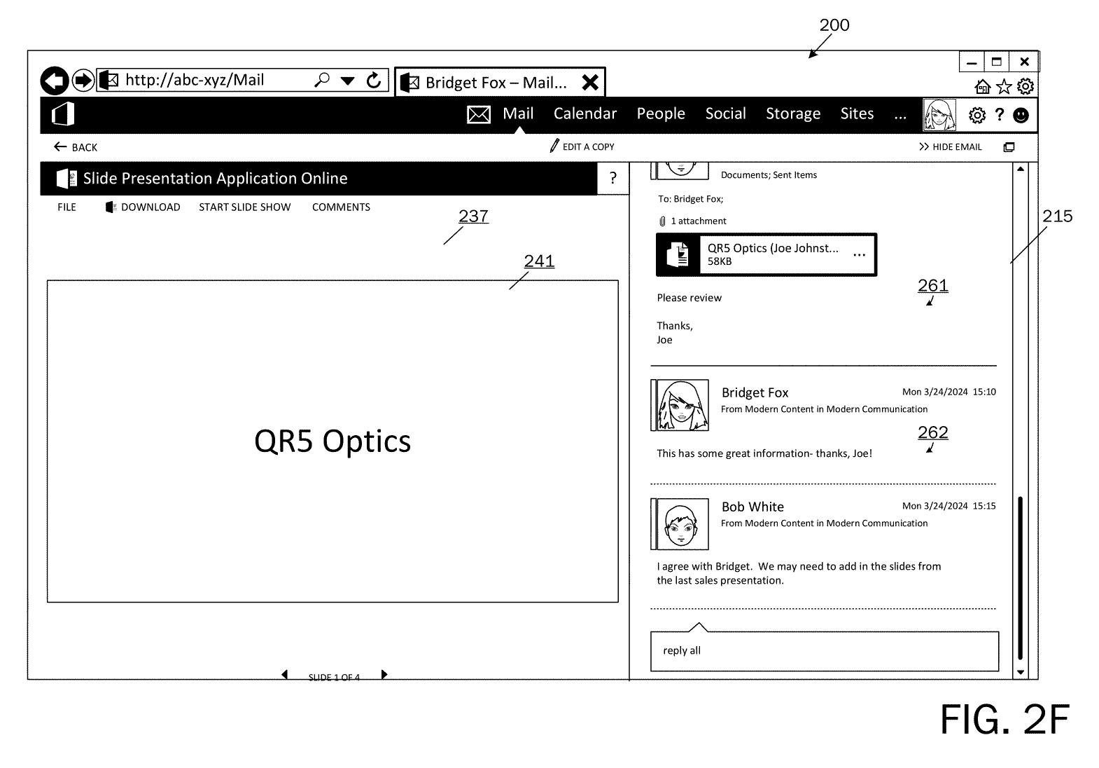

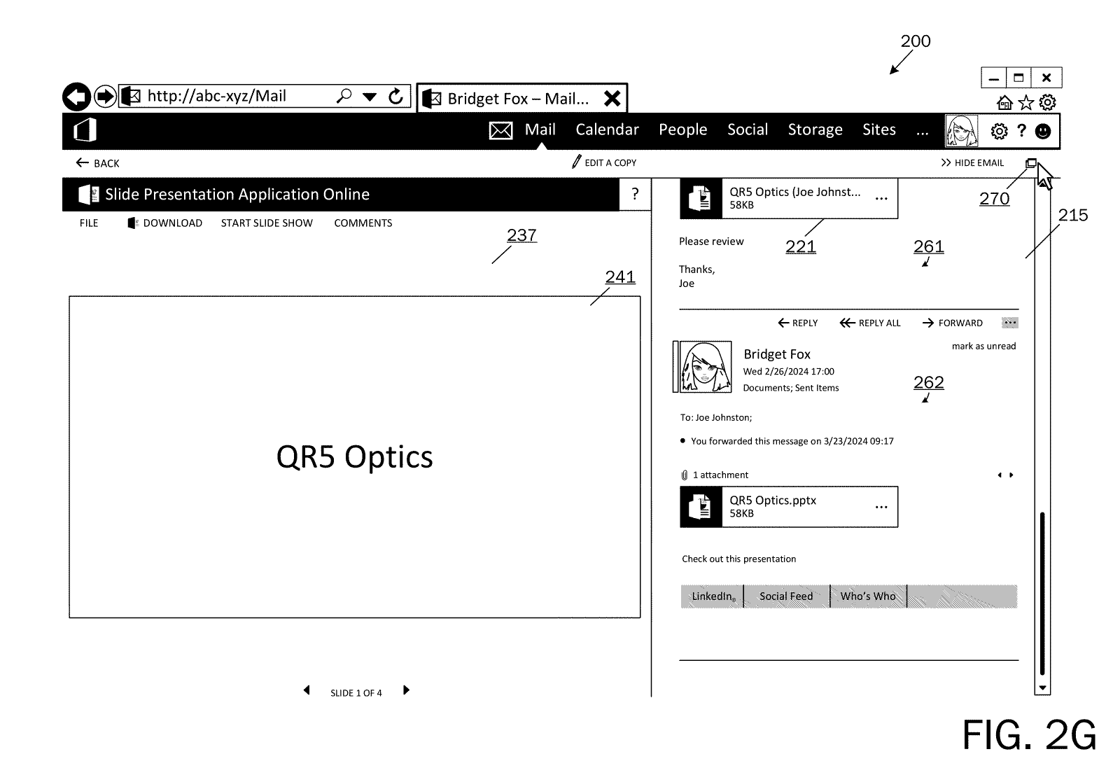

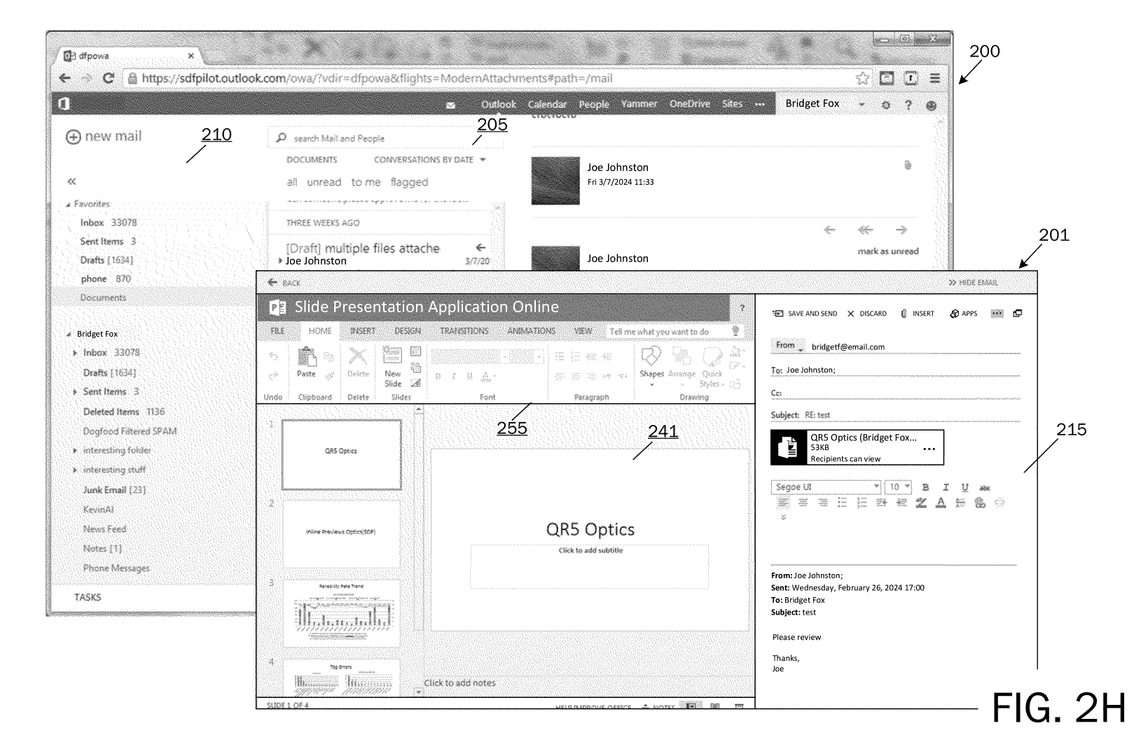

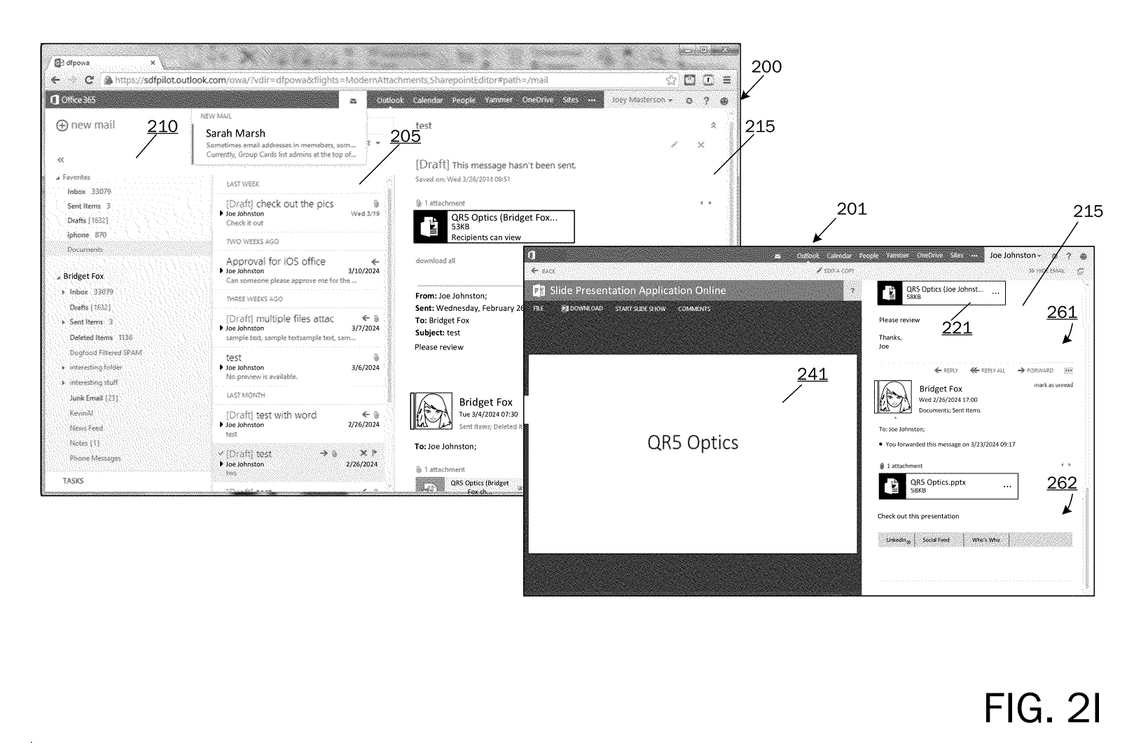

FIG. 2A illustrates a computer-generated user interface of an electronic communication application with which embodiments the present invention may be practiced. An example electronic communication application suitable for embodiments described herein includes OUTLOOK from Microsoft Corporation. As illustrated in FIG. 2A, a user interface 200 for an example electronic mail application with which a user may send and receive a variety of electronic messages, and with which a user may send and receive content item attachments according to embodiments of the present invention is illustrated. An electronic mail folder pane 210 is illustrated on the left side of the user interface 200 in which a variety of folders, contact items, group items, calendar items, and the like, may be provided to allow a user to select various folders, contacts, or other items associated with her electronic communication application functionality. An electronic communication items folder 205 is illustrated in which a variety of electronic communication items received by the receiving user are displayed that may be selectively reviewed and responded to according to the functionality of the associated electronic communication application. For example, the pane 205 may include an inbox for listing all received electronic mail items, a sent box for listing sent electronic mail items and/or the contents of a given folder of electronic communication items.

On the right side of the example user interface 200 is displayed an electronic mail viewing pane in which a given electronic communication message or electronic communication conversation thread of items may be displayed for allowing a user to read or otherwise interact with a given electronic communication message, for example, replying to the message, forwarding the message, and the like. That is, upon selection of a given communication item (e.g., an electronic mail item) listed in an inbox displayed in the pane 205, the selected item may be opened in the pane 215 to allow the user to read or respond to the communication item. If the selected communication item contains a thread of multiple communication items comprising a communication conversation, then the entire thread of items may be displayed in the pane 215 to allow the user to navigate through the various items in the thread. As should be appreciated, the electronic communications items illustrated in the electronic communications pane or canvas 215 may comprise an electronic communications thread of a number of electronic communications items associated with a single selected item from the electronic communications item pane 205.

For example, in the electronic communication items 205, a user may have received an electronic mail from a given sender, for example sender “Joe Brown.” Upon selecting the email from the example sender “Joe Brown” listed in the electronic mail items pane 205, the corresponding electronic communication item along with a showing of any attachment icons associated with the attached content items, will automatically be displayed in the electronic communications pane or canvas 215. In addition, if the selected electronic communication item is part of an electronic communications thread containing a number of different electronic communications items (for example, five different electronic mail items exchanged between various users as part of a communications thread), then the entire electronic communications thread may be displayed in the electronic communications pane or canvas 215 for allowing the user to navigate through the items contained in the thread by navigating the electronic communications pane or canvas 215 as desired.

In addition, other types of information may be shown in the electronic communications pane 215, including calendar entries, task entries, reminder entries, and the like. In each of such types of entries, for example, a calendar entry, an attachment may be contained which when selected from the example calendar entry may cause a display of the associated content item in the immersive view pane, described below. For example, a user may launch a calendaring function in the communications pane 215 showing calendar entries for a given day. Upon navigating through various calendar entries for the given day, one of the calendar entries may have an attached document that will be discussed with other users during a given meeting. Selection of an attachment icon in the calendar entry may cause an automatic display of the associated content item in the immersive view pane 237 to allow the user to review and/or edit the corresponding content item. Once edits are completed to such a content item, an updated meeting request or calendar entry may be automatically prepared for sending to other participants in the example meeting and the edited content item may be automatically attached to the meeting update for sending to the other participants in the meeting.

As illustrated in FIG. 2A, an example electronic mail message 259 has been received by the receiving user and has been opened in the electronic communications pane or canvas 215. The received electronic mail message includes three example attachments 219, 225, 230. As should be appreciated, the attachments 219, 225, 230 are illustrative of any attached content item, for example, a word processing document, a spreadsheet document, a slide presentation document, a notes document, an image file, a photograph, a video file, and the like, that may be received by the receiving user from a sending user.

According to embodiments of the present invention, if a user selects one of the attached content items 219, 225, 230, the selected content item may be displayed in an immersive view pane 237 for allowing a user to view and/or edit the selected content item. As illustrated in FIG. 2A, an example user selects the example word processing document attachment icon 219 for viewing and interacting with the selected document 219, as described herein.

Referring now to FIG. 2B, in response to the receiving user's selection of the attachment item 219, as illustrated in FIG. 2A, the associated document 240 is automatically displayed in an immersive view pane 237 for allowing the user to review and interact with the associated document 240. As illustrated in FIG. 2B, the immersive view pane is positioned on the left side of the user interface 200, and the electronic mail view pane 215 remains displayed on the right side of the user interface 200. As should be appreciated, the respective viewing panes may be displayed in other orientations, for example in a right/left orientation where the immersive view pane is displayed on the right side of the user interface and the electronic mail pane is displayed on the left, a top/bottom orientation where the immersive view pane is displayed on the top of the interface 200 and the electronic communication pane is displayed on the bottom of the interface 200, or a bottom/top orientation where the immersive view pane is displayed on the bottom of the interface 200 and the electronic communication view pane is displayed on a top of the interface 200. Alternatively, if the computing device in use by the receiving user is a small form device, such as a tablet computing device or mobile phone, and display space is insufficient for displaying both the immersive view pane and the electronic communication view pane, then the immersive view pane 237 may be displayed over the entire display surface of the computing device, and a functionality button or control may be provided for selectively returning the electronic communication view pane to display, as desired. Alternatively, a truncated display of the electronic communication view pane may be provided and the remaining display space may be used for the immersive view pane.

According to embodiments of the present invention, if a user selects an edit function in the user interface 200 or performs an edit on the document 240 (e.g., change a text item in the document 240), an application associated with the content item type for the content item displayed in the immersive view pane may be launched in the immersive view pane or one or more functionalities associated with the content item type may be provided in the immersive view pane to allow the user to edit the displayed document. As illustrated in FIG. 2B, a variety of word processing functionalities 255 may be provided in the immersive view pane for allowing the receiving user to edit the document 240. As should be appreciated, an instance of a word processing application may be launched and displayed in the immersive view pane, or selected functionalities, for example, formatting functionalities may be provided in the immersive view pane for allowing a user to operate certain word processing functions on the document 240. Likewise, if the document 240 is another type of document, such as a spreadsheet document, then an instance of a spreadsheet application may be launched in the immersive view pane, or certain functionalities of a spreadsheet application may be provided in the immersive view pane. That is, any type of software application functionality may be provided in the immersive view pane as required for editing the displayed content item. As should be appreciated, if the user desires to edit a portion of the document 240 not associated with the example word processing application, for example, the photograph of a dog contained in the document 240, then functionalities required for editing an image such as the photograph of the dog may be provided to allow the user to edit the image.

Referring still to FIG. 2B, according to one embodiment, when the receiving user selects the document 240 for editing, a draft communication, for example, a draft reply electronic mail item 261 may be automatically generated and displayed in the electronic communication view pane to allow the user to communicate the edited document or other content item when the user completes the editing process. Referring to the draft communication 261, according to one embodiment, an automatic reply message to the original sender of the electronic mail message that attached the document 240 that is being edited by the receiving user may be generated so that upon completion of edits to the document 240, the editing user may select a save and send function 260 for automatically attaching the edited version of the document or content item 240 to the draft communication 261 for sending the communication to the original sending user. Thus, a communication from the sending user to the receiving user is enabled where the receiving user opens an attachment received from the sending user, edits the attachment and automatically sends the edited version of the attachment back to the original sending user without the need for saving the attachment to a hard drive or other storage repository at which edits are made and saved followed by a retrieval and re-attachment of the edited content item to a communication for transmitting to the original sending user.

If the receiving user selects the save and send function 260, then the user interface 200 for the example electronic mail application may be returned back to a state wherein the folders pane 210, the electronic communication items pane 205, and the electronic communication view pane 215, are presented, but where a reply communication 265 is illustrated with which the user may send an attachment 220 of the edited version of the originally received attachment back to the original sending user. As should be appreciated, the receiving user may enter one or more text strings such as the string “I've made some changes. Let me know what you think.”, or with which the user may attach one or more additional documents or other content items for sending to the original sending user.

As illustrated in FIG. 2C, the electronic communications pane or canvas 215 contains a communications thread comprised of a number of electronic mail messages 261 and 262 comprising an electronic communications thread between a variety of users. As should be appreciated, the communications thread illustrated in the communications pane 215 may have been displayed as a result of the user selecting one of the electronic communication items listed in the electronic communications items pane 205, illustrated in FIG. 2A. Referring still to FIG. 2C, a document 241 is illustrated as displayed in the immersive view pane 237 to allow a review and potential editing of the displayed document. According to an embodiment, the document 241 may have been displayed as a result of a selection of the attachment icon 221 in the communication 261 illustrated in the communications pane 215.

Referring now to FIG. 2D, according to an embodiment, as the user navigates through various communication items contained in a given communications conversation thread, the user may select other attachment icons for displaying associated content items in the immersive view pane. As illustrated in FIG. 2D, a user selects the attachment icon 223, and as a result, a document 242 is automatically displayed in the immersive view pane 237 to replace the document 241 that was previously displayed in the immersive view pane, as illustrated in FIG. 2C. Thus, a user may select different attachments across an entire conversation thread for changing which content items are displayed in the immersive view pane 237 while maintaining the desired communications thread in the communications pane or canvas 215.

Referring now to FIG. 2E, according to embodiments, the electronic communications pane or canvas 215 may be utilized for displaying different types of electronic communications. For example, a chat session user interface 265 is illustrated in the electronic communications pane 215. As should be appreciated, other types of communications items and/or communications thread may include text messaging communications, instant messaging communications, electronic mail communications, video communications, and the like. In any of such communications, having one or more attachments, selection of the associated attachment icon or links may cause a display of the associated content items in the immersive view pane 237. According to embodiments, if a user edits a displayed content item, a next or responsive communication may be automatically generated in the pane 215, for example, a next text message, a next instant message, a next email message, a next chat message, or the like, for automatically sending the edited content item as an attachment to a desired recipient. In such a case, the edited content item may be stored with the communication item at an appropriate server, for example, the mail box server 108, or the edited item may be stored at an alternate storage location, such as the collaboration server 112, and an attachment automatically generated for an automatically-generated communication may include a pointer to the stored edited content item.

Referring now to FIG. 2F, an enhanced view ordering for items contained in a given communications conversation thread displayed in the communications pane 215 is illustrated and described. Referring to FIG. 2F, a conversation thread is displayed in the communications pane 215, as described above. In response to selection of a given attachment icon, a document 241 has been displayed in the immersive view pane 237. Referring to the view pane 215, according to embodiments of the present invention, when a user selects a given communications item, for example, an electronic mail item, a corresponding communications conversation thread is displayed in the view pane 215 in an order from oldest to newest, where oldest items in the thread are displayed at the top of the thread, followed by next-newer items, followed by next-newer items, and so on. Thus, when the user navigates through the items contained in the communications thread, the first item at the top of the thread will be the oldest item contained in the thread, the next item contained in the thread will be the next-newer item, and so on. Thus, the user may very quickly and efficiently navigate through items contained in the thread while knowing that if the user wishes to see the very first item in the thread, that began the conversation, the user may navigate to the top of the listing of the items, and that the user may navigate through the thread by navigating (e.g., scrolling) down through the items contained in the communications thread.

Thus, the communications pane becomes a reading pane that allows the user to read communications contained in the thread from top to bottom while simultaneously reviewing attached content items by selecting associated attachment icons for causing a display of the associated content items in the immersive view pane 237. According to this embodiment, if a user decides to edit a given content item, an automatically-generated next communications item will be added to the bottom of the communications thread, and an edited version of the document may be attached to the new communications item. Alternatively, if the user wishes to simply add a new communication item, for example, a responsive email message, to the communications thread to make a comment about a given content item, for example, when the user selects to respond, for example, reply, forward, etc., to a previous email communication in the thread, the new communication will be created at the bottom of the communications thread, as illustrated in FIG. 2F.

Referring now to FIG. 2G, according to another embodiment, a pop-out function 270 is illustrated and described. As described herein, and as illustrated in FIGS. 2B through 2F, when a user selects a given attachment contained in an electronic communications item, the associated content item is automatically displayed in the immersive view pane 237 to allow the user to view the displayed document while simultaneously navigating, viewing and/or responding to communication items in the pane in a corresponding communications thread in the pane 215. According to an embodiment, a pop-out function 270, may be selected by the user, and as illustrated in FIG. 2H, a secondary user interface 201 may be popped-out from the primary user interface 200 in a partial or total overlay relative to the user interface 200.

In the popped-out interface 201, the communications thread illustrated in the communications pane 215 and any displayed content items 241 displayed in the immersive view pane 237 will be displayed in the popped-out user interface 201, and the original user interface 200 from which the pop-out user interface is pulled may return back to a different display state, for example, a starting state from which the original electronic communication was selected, as illustrated above with reference to FIG. 2A. That is the user's folder pane 215, electronic mail items pane 205 (e.g. inbox), and the electronic communications pane 215 may be displayed in the primary user interface 200, and in the popped-out secondary user interface 201, the currently being-navigated communications conversation thread and any being-viewing and/or edited content items will be displayed in the popped-out user interface 201.

Referring now to FIG. 2I, according to an embodiment, any edits made or changes made in either the popped-out secondary user interface 201 or the primary user interface 200 from which the popped out user interface 201 is pulled will be reflected in the other of the two user interfaces. That is, if the original user interface 200 serves as a primary user interface and the popped-out user interface 201 serves as a secondary user interface, then any changes or updates made in the primary user interface will be reflected in the secondary user interface and vice versa. Thus, even though the immersive view pane 237 with a displayed content item and the associated communications view pane 215 consume some or all of the display space, by showing those items in a popped-out user interface 201, the user may very quickly navigate back and forth between the primary and secondary user interfaces, as desired. According to this embodiment, the user may pop the secondary user interface 201 back into the primary user interface by selecting the pop out control 270 a second time or by some other suitable function selection. As should be appreciated, the user interface components, layouts, functionality buttons and controls, illustrated and described herein are for purposes of example and illustration only and are not restrictive of other layouts and orientations that may be used in accordance with embodiments of the present invention.

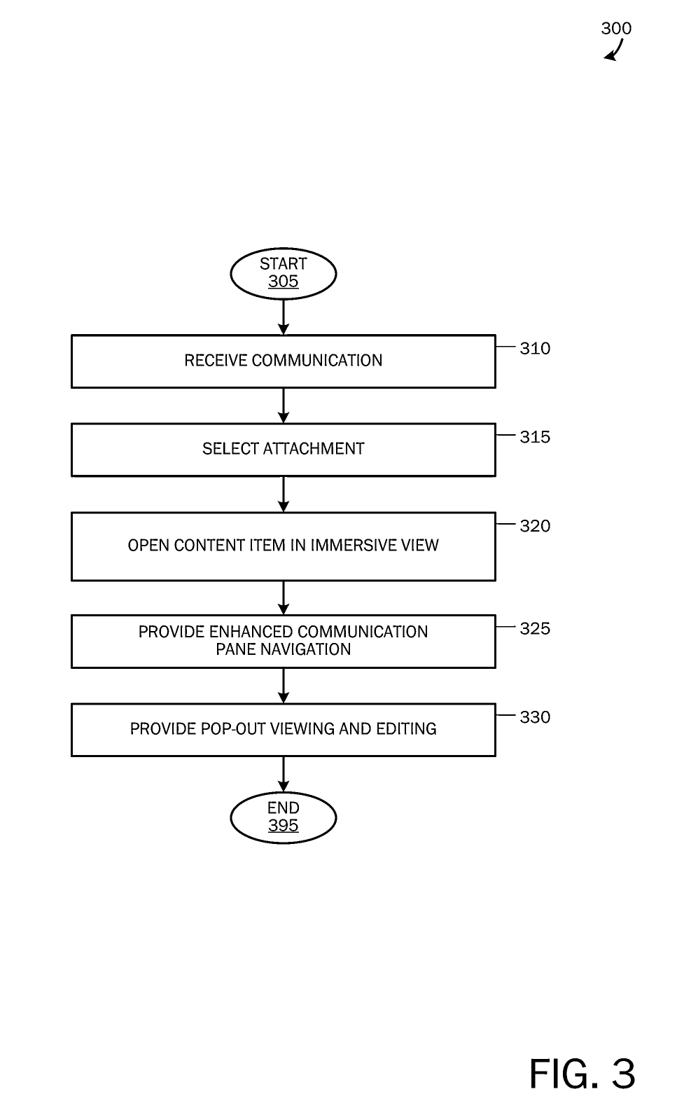

Having described a system architecture, various user interface components and various aspects of embodiments of the present invention with respect to FIG. 1 through 2I, FIG. 3 is a flowchart illustrating a method for immersive document viewing and use. The routine 300 begins at start operation 305 and proceeds to operation 310 where a communication of one of various types is received by a user. For example, the user may receive an electronic mail message, a text message, an instant message, a chat session message, a video message, or the like. According to one embodiment, the received communication may be first received in and listed to the user in a communications item pane 205, as illustrated and described above with reference to FIG. 2A. Upon selection of the received communication from the pane 205, the selected communication along with any associated communications comprising a communications conversation thread will be displayed in the electronic communications pane or canvas 215, as illustrated and described herein.

If the received communications item, or if another communications item contained in an associated communications conversation thread includes an attachment, at operation 315, the user may select the attachment, and at operation 320, a content item associated with the selected attachment may be automatically displayed in the immersive view pane 237. According to embodiments of the present invention, the user may navigate through various communications items contained in a given communications conversation thread, and the user may select attachments contained in various communications items contained in the thread, and content items associated with selected attachments may be automatically displayed in the immersive view pane 237.

At operation 325, communication items provided in the communications pane 215 may be oriented in an oldest-to-newest orientation such that oldest items in the thread are displayed at the top followed by newer items, followed by newer items, and so on to allow a user an efficient top to bottom navigation of items contained in a communications conversation thread.

At operation 330, if a user desires to review or edit a content item in association with one or more communications, the user may select the pop-out function 270 for popping-out a secondary user interface 201 from a primary user interface 200 to allow a user to review, edit, or communicate in association with a given content item in a secondary user interface while simultaneously having a primary communications user interface remain in a primary user interface. According to embodiments, the user may then navigate back and forth between the primary and secondary user interfaces, as desired, and any changes made to any content items or communication items contained in either the primary or the secondary user interface may be reflected in the other of the two user interfaces. The routine ends at operation 395.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

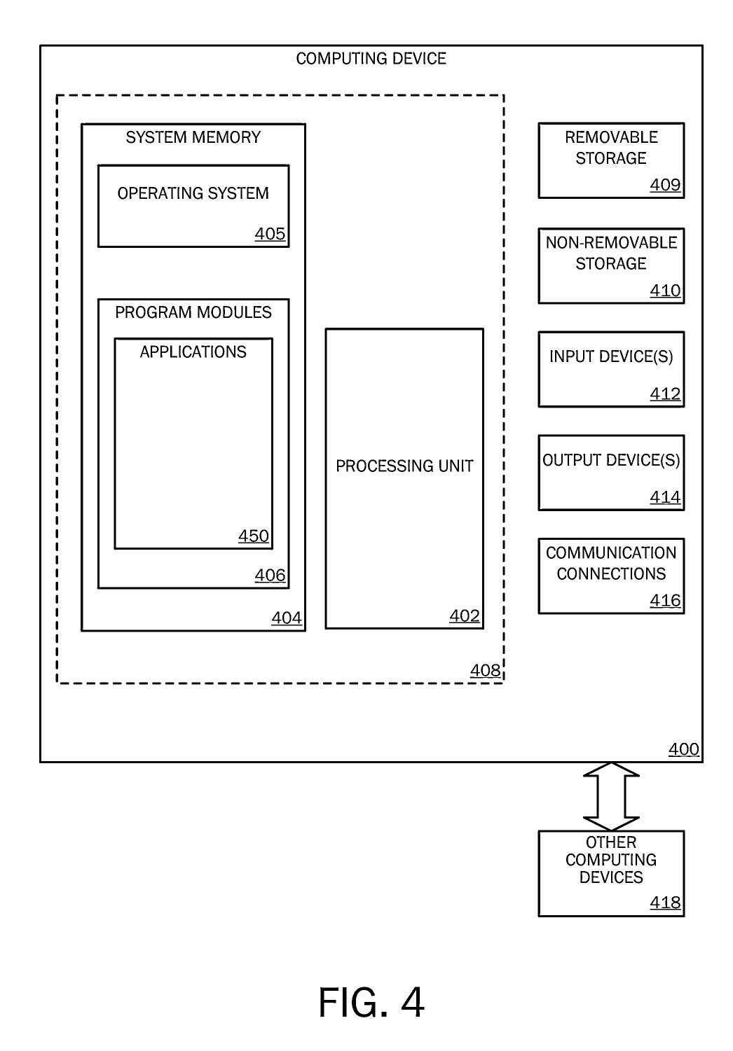

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the client device 104a-n described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

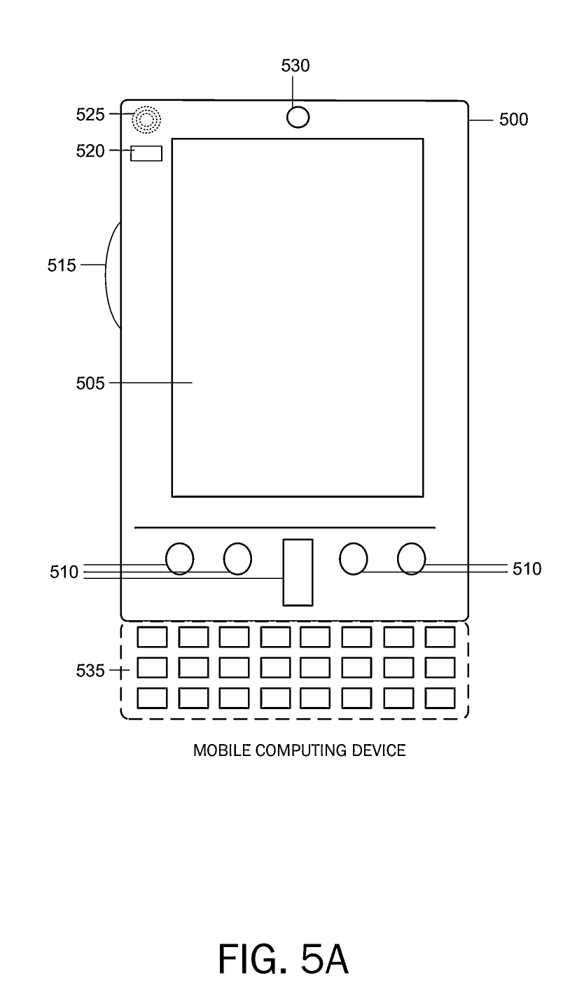

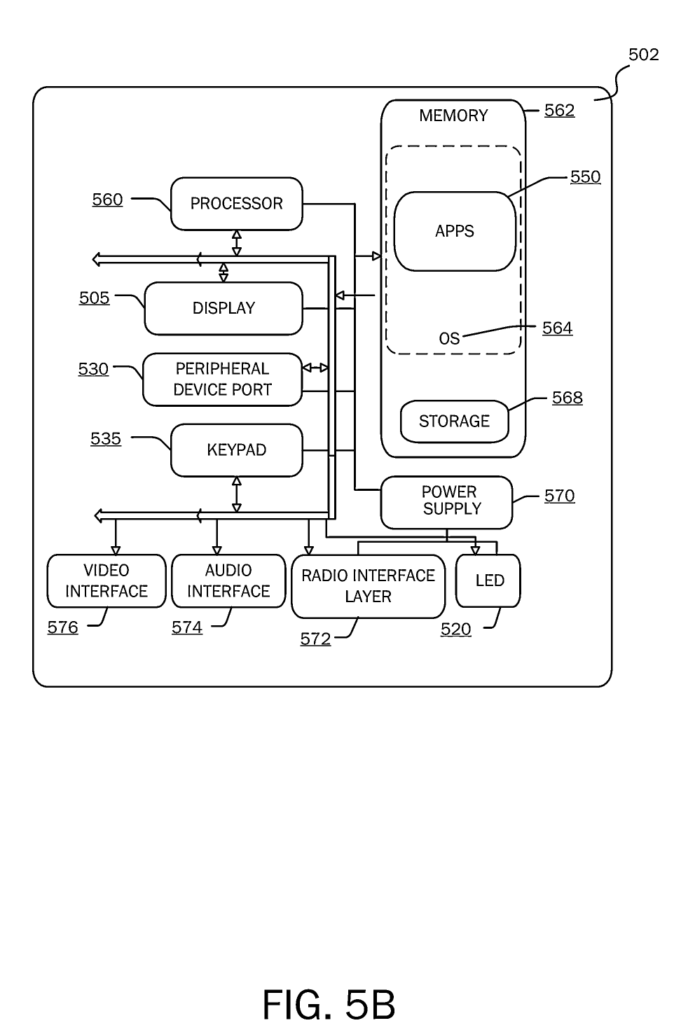

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, electronic communication applications, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

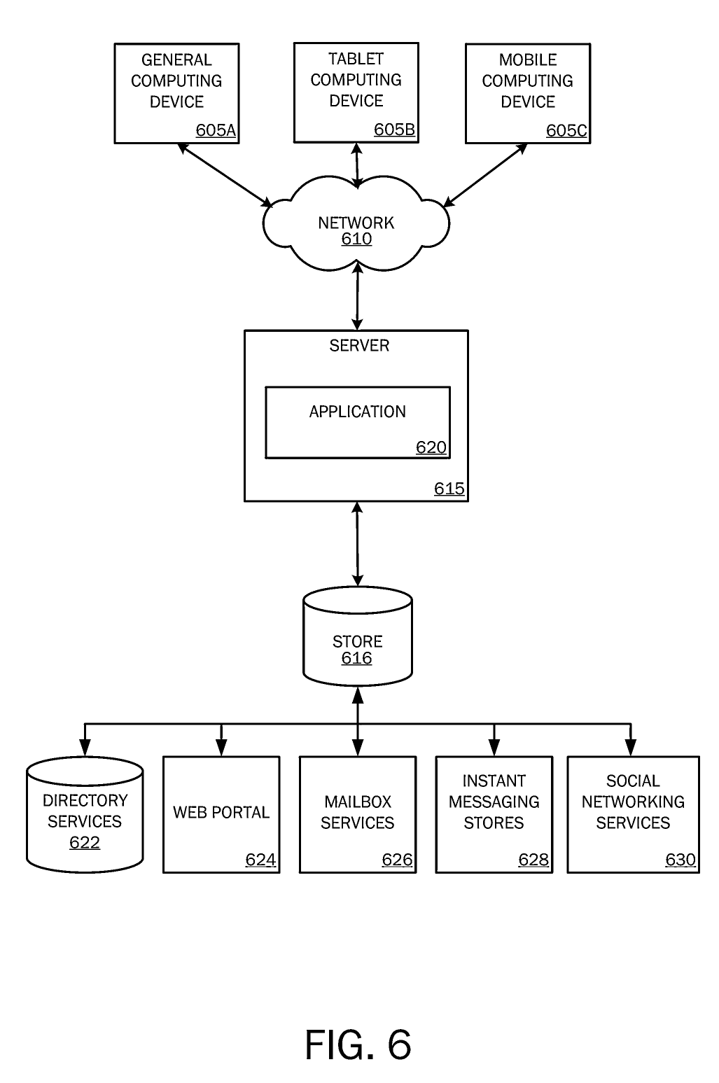

FIG. 6 illustrates one embodiment of the architecture of a system for providing the functionality described herein across components of a distributed computing environment. Content developed, interacted with, or edited in association with the applications described above may be stored in different communication channels or other storage types. For example, various documents may be stored using a directory service 622, a web portal 624, a mailbox service 626, an instant messaging store 628, or a social networking site 630. The application 620 (e.g., an electronic communication application) may use any of these types of systems or the like for providing the functionalities described herein across multiple workloads, as described herein. A server 615, 108 may provide the functionality to clients 605A-C and 104A-N. As one example, the server 615, 108 may be a web server providing the application functionality described herein over the web. The server 615, 108 may provide the application functionality over the web to clients 605A-C and 104A-N through a network 120, 610. By way of example, a client computing device 104A-N may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing immersive document view and use in an electronic communications user interface, comprising:
in a computer-generated electronic communications user interface, providing a communications pane in which is disposed one or more electronic communications where at least one of the one or more electronic communications includes a content item attachment; and
in response to a selection of the content item attachment, displaying an associated content item in an immersive view pane in the electronic communications user interface for allowing a view of both the displayed content item and the one or more electronic communications in a single display of the electronic communications user interface.

2. The method of claim 1, wherein the communications pane and the immersive view pane are displayed in the computer-generated user interface in side-by-side orientation.

3. The method of claim 1, wherein the communications pane and the immersive view pane are displayed in the computer-generated user interface in top-to-bottom orientation.

4. The method of claim 1, wherein if a display space available in the computer-generated electronic communications user interface is insufficient to display both the communications pane and the immersive view pane, truncating a display of the communications pane to allow a display of the immersive view pane.

5. The method of claim 1, wherein the one or more electronic communications are of a communications type belonging to one or more of an electronic mail communication, a text message communication, a chat session communication, an instant messaging communication, a video communication, an electronic calendar item, an electronic task item, and an electronic reminder item.

6. The method of claim 1, wherein the one or more electronic communications disposed in the communications pane comprise a communications thread and further comprising allowing a navigation in the communications pane of the one or more communications comprising the communications thread while maintaining a display of the displayed content item in the immersive view pane.

7. The method of claim 6, in response to a selection of a second content item attachment attached to one of the navigated communications comprising the communications thread, replacing a display of the displayed content item in the immersive view pane with a display of a second content item associated with the second content item attachment.

8. The method of claim 6, wherein the one or more electronic communications disposed in the communications pane are disposed in an oldest received to newest received order where the oldest received communication is disposed at the top of the communications thread such that a downward navigation of the communications thread allows for navigation to successively newer electronic communications.

9. The method of claim 8, wherein if an additional communication is added to the communications thread either as a responsive communication or as a new communication, adding the additional communication to a bottom of the communications thread as a newest communication in the communications thread.

10. The method of claim 1, further comprising,
in response to the selection of the content item attachment, displaying a secondary user interface over the computer-generated electronic communications user interface as a pop-out secondary interface;
displaying the communications pane and the immersive view pane in the pop-out secondary interface; and
returning the computer-generated electronic communications user interface to a display state prior to providing the communications pane.

11. The method of claim 10, further comprising allowing navigation between the pop-out secondary interface and the computer-generated electronic communications interface for allowing a selective review of contents of the two interfaces on command.

12. The method of claim 10, further comprising allowing a selective popping of the pop-out secondary interface back into the computer-generated electronic communications interface such that the computer-generated electronic communications interface is returned to a display state prior to popping the pop-out secondary interface out of the computer-generated electronic communications interface.

13. The method of claim 10, wherein in response to receiving any changes or additions to any communications contained in the communications pane or in response to receiving any changes to any content items displayed in the immersive view pane, automatically reflecting the changes or additions to any communications or changes to any content items in corresponding communications or content items contained in or displayed in the electronic communications user interface.

14. The method of claim 10, wherein displaying the pop-out secondary interface includes displaying the pop-out secondary interface in a partially overlaying disposition over the electronic communications user interface.

15. The method of claim 10, wherein displaying the pop-out secondary interface includes displaying the pop-out secondary interface in a completely overlaying disposition over the electronic communications user interface.

16. A computer-generated user interface, comprising:
a communications pane in which is disposed one or more electronic communications; and
an immersive view pane displayed in the computer-generated user interface in response to a selection of a content item attachment contained in one of the one or more electronic communications wherein a content item associated with the content item attachment is displayed in the immersive view pane;
wherein the communications pane and the immersive view pane are displayed in the computer-generated user interface to allow a viewing of both the communications pane and the immersive view pane in a single display of the computer-generated user interface.

17. The computer-generated user interface of claim 16, wherein the communications pane and the immersive view pane are displayed in the computer-generated user interface in side-by-side orientation.

18. The computer-generated user interface of claim 16, wherein the communications pane and the immersive view pane are displayed in the computer-generated user interface in top-to-bottom orientation.

19. The computer-generated user interface of claim 16, further comprising:
a primary interface for displaying one or more of electronic communications items; and
a pop-out secondary interface for displaying the communications pane and the immersive view pane, the pop-out secondary interface being displayed over the primary interface upon selection of an electronic communications item from the primary interface wherein the one or more electronic communications disposed in the communications pane are related communications displayed in the communications pane in response to the selection of the electronic communications item from the primary interface.

20. A computer-readable medium containing computer executable instructions, which when executed by a computer perform a method for providing immersive document view and use in an electronic communications user interface, comprising:
in a computer-generated electronic communications user interface, providing a communications pane in which is disposed one or more electronic communications where at least one of the one or more electronic communications includes a content item attachment;
in response to a selection of the content item attachment, displaying an associated content item in an immersive view pane in the electronic communications user interface for allowing a view of both the displayed content item and the one or more electronic communications in a single display of the electronic communications user interface; and
wherein the one or more electronic communications disposed in the communications pane comprise a communications thread and further comprising allowing a navigation in the communications pane of the one or more communications comprising the communications thread while maintaining a display of the displayed content item in the immersive view pane.
